(19) United States
(12) Patent Application Publication
(10) Pub. No.: US 2006/0250915 A1
(43) Pub. Date: Nov. 9, 2006

(54) Apparatus and method for decoding data encoded in wobbeed pattern of a recording medium

(75) Inventor: Jung Bae Park, Anyang-Si (KR)

Correspondence Address: BIRCH STEWART KOLASCH & BIRCH, PO BOX 747, FALLS CHURCH, VA, 22040-0747, US

(73) Assignee: LG Electronics, Inc, Seoul (KR)

(21) Appl. No.: 10/559,125

(22) PCT Filed: Jun. 1, 2004
(86) PCT No.: PCT/KR04/01294

§ 371 Date: May 17, 2006

(30) Foreign Application Priority Data
Jun. 2, 2003 (KR) 1020030035309

(51) Int. Cl. G11B 7/00

(52) U.S. Cl. 369/53.34

(57) ABSTRACT

The present invention relates to apparatus and method for decoding data encoded in wobbled pattern of a recording medium, especially, a recordable optical disk. In the present invention, a periodic clock signal is used to decode a wobble signal produced from wobbled pattern of a recording medium. The period of the clock signal is equal to time length of a wobble segment where 1 bit is encoded in the wobble signal. The bit value encoded in the wobble segment is determined to ‘1’ or ‘0’ based on the detected property value in decoding process.

### BACKGROUND OF THE INVENTION

1. Technical Field

The present invention relates to apparatus and method for decoding data encoded in wobbled pattern of a recording medium such as a recordable optical disk.

2. Background Art

The standardization of new high-density optical disks capable of recording large amounts of high-quality video and audio data has been progressing rapidly. Blu-ray Disk Read-Only (BD-ROM), Blu-ray Disk Write-Once (BD-R), and Blu-ray Disk Rewritable (BD-RE) are examples of these new optical disks. If the standardization of these optical disks is complete, new optical disk-related products are expected to be commercially available on the market in the near future.

As shown in FIG. 1, a BD-RE is organized, in the radial direction, into a clamping area, a burst cutting area (BCA), a transition area, a lead-in area, a data area, and a lead-out area.

The lead-in area is organized into a first guard (Guard 1) area, a permanent information and control data (PIC) area, a second guard (Guard 2) area, an information (Info 2) area, and an optimum power calibration (OPC) area. While the Guard 1 area and the PIC area are pre-recorded areas, the others of the lead-in area, the data area, and the lead-out area are all rewritable areas.

The PIC area is used to store a disk information (DI) that should be kept permanently. The DI is Bi-phase high-frequency modulated (HFM) and recorded in the wobbled pattern along the track on the disk in such a way that the wobbled patterns encoding ‘1’ bit information has phase transition and the wobbled pattern encoding ‘0’ bit information has no phase transition, as shown in

FIG. 2. The wobbled pattern where one bit information is encoded is 36 T long.

On the other hand, a bi-phase synchronization pattern that consists of a sync body and a sync identification precedes an area where data of the disk information (DI) are written, as shown in FIG. 3. The sync identification comprises three-bit code (ID0, ID1, ID2) and a one-bit parity. As shown in FIG. 4A, the sync identification has seven possible code values (FS0 to FS6) which are called frame syncs. The frame sync is recorded in each recording frame in the PIC area in accordance with a predetermined mapping of FIG. 4B.

A method of accurately, reliably decoding data encoded in the wobbled patterns shown FIGS. 2 to 4 is demanded rapidly.

3. Disclosure of the Invention

It is an object of the present invention to provide an apparatus and method for accurately, reliably decoding data encoded in wobbled pattern of high-density optical disks such as BD-ROM and BD-RE.

In accordance with the present invention, there is provided an apparatus for accurately, reliably decoding data encoded in wobbled patterns of a high-density optical disk, comprising an optical pickup for outputting a wobble signal from wobbled pattern of an optical disk; a detector for detecting a property value of a wobble segment by using a clock signal whose period is equal to time length of the wobble segment where 1 bit is encoded in the wobble signal; and a determining unit for determining the bit value encoded in the wobble segment on the basis of the detected property value.

According to an embodiment of the present invention, the clock signal and the wobble segment are exclusive-ORed, inverted, and integrated, and used to determine the bit value encoded in the wobble segment. The bit value encoded in the wobble segment is determined to ‘0’ (‘1’) if the integrated value is approximately equal to 50% (0% or 100%) of a predetermined maximum integration value.

According to another embodiment of the present invention, two level values of the wobble segment at 25% and 75% points of the wobble segment are detected on the basis of the clock signal and then are compared to determine the bit value encoded in the wobble segment. If the two level values are equal to each other, the bit value is determined to ‘0’, and ‘1’ otherwise.

In the foregoing embodiment, the 25% and 75% points of the wobble segment are detected on the basis of the level transition points of a new clock signal that is produced by frequency-multiplying the clock signal by 2. Also, the 25% and 75% points of the wobble segment can be detected on the basis of the level transition points of a delayed clock signal that is produced by delaying the clock signal by ¼ period.

### BRIEF DESCRIPTION OF THE DRAWINGS

In the drawings:

FIG. 1 illustrates a dick structure of a BD-RE;

FIG. 2 illustrates a bi-phase high-frequency modulated groove recorded in the PIC area of a BD-RE;

FIG. 3 illustrates sync patterns of disk information encoded in the wobbled pattern of a BD-RE;

FIG. 4A illustrates frame sync identifications that are to be allocated to recording frames of FIG. 3;

FIG. 4B is a table showing a mapping of frame sync identification in accordance with recording frame number;

FIG. 5 illustrates a partial block diagram of an optical disk reproducing apparatus of the present invention;

FIG. 6 illustrates a block diagram of decoding apparatus of the first embodiment of the present invention;

FIG. 7 illustrates a method of decoding data encoded in wobbled pattern by the apparatus of FIG. 6;

FIG. 8 illustrates a block diagram of decoding apparatus of the second embodiment of the present invention;

FIG. 9 illustrates a method of decoding data encoded in wobbled pattern by the apparatus of FIG. 8;

FIG. 10 illustrates a block diagram of decoding apparatus of the third embodiment of the present invention; and

FIG. 11 illustrates a method of decoding data encoded in wobbled pattern by the apparatus of FIG. 10.

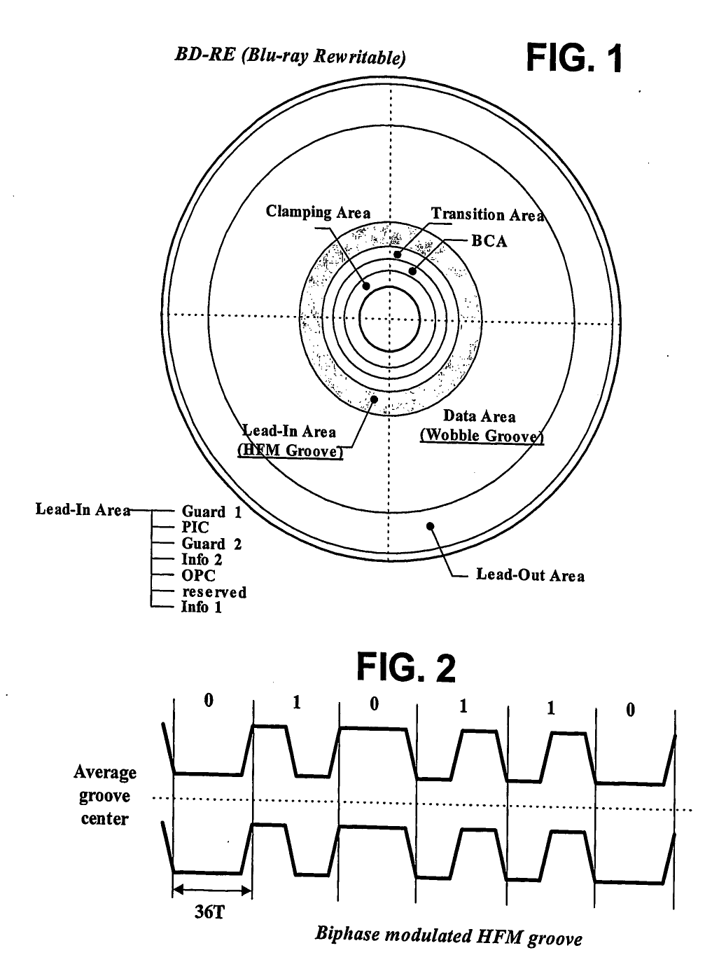

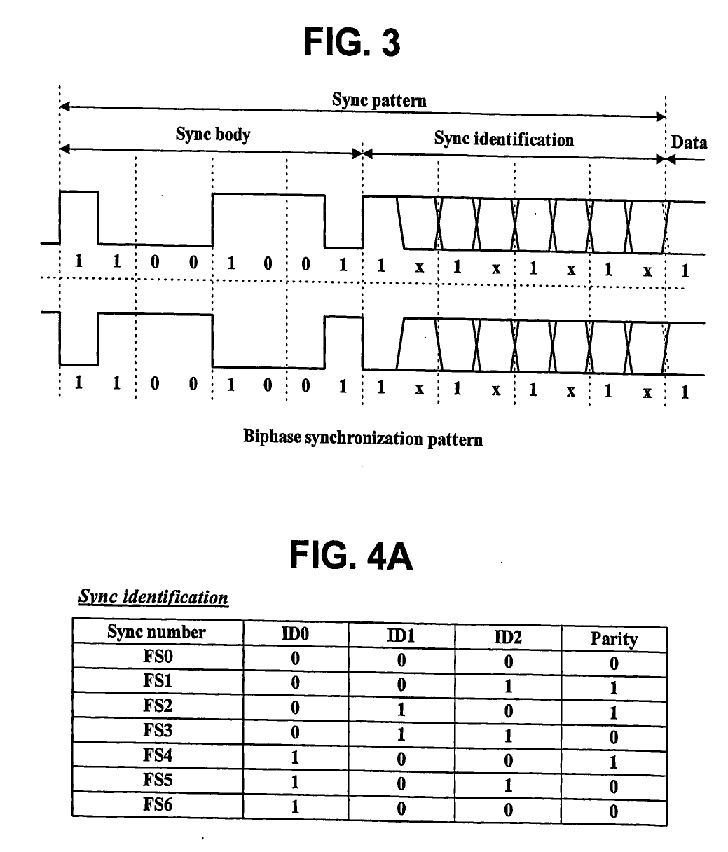

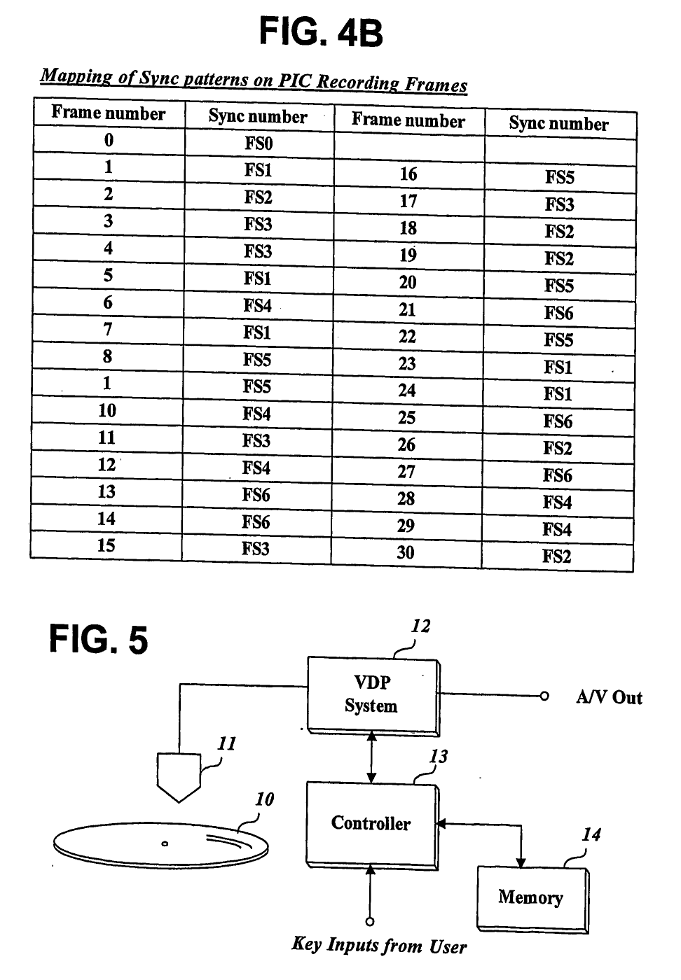

### BEST MODE FOR CARRYING OUT THE INVENTION

In order that the invention may be fully understood, preferred embodiments thereof will now be described with reference to the accompanying drawings.

The apparatus and method of decoding data encoded in the wobbled pattern according to the present invention is applicable to an optical disk reproducing apparatus of FIG. 5 which comprises an optical pickup 11 for reading out signal and/or wobbled pattern recorded on an optical disk 10; a video disk play (VDP) system 12 for processing and decoding the read-out signal; a microcomputer 13 for performing servo-control operations and playback operations according to user's request and navigation data; and a memory 14 for storing temporary playback control data.

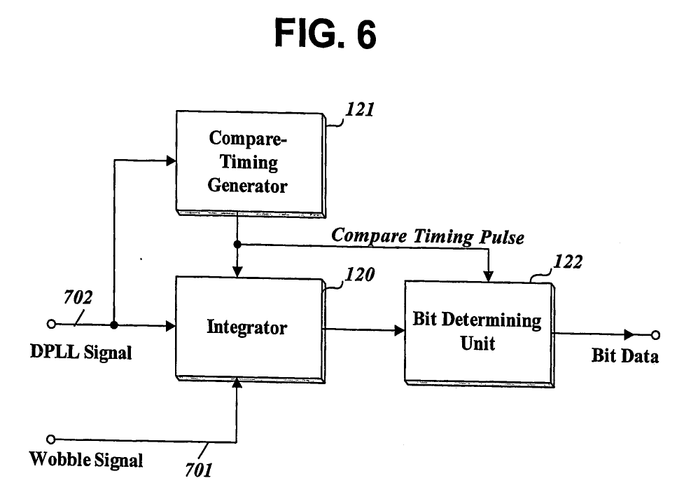

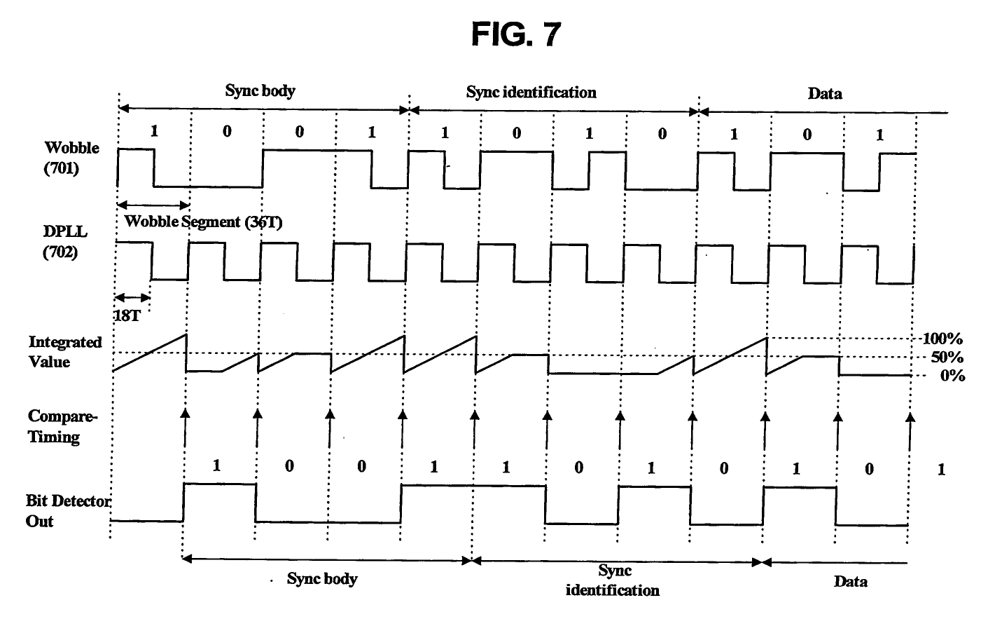

The decoding apparatus in accordance with the present invention is implemented in the VDP system 12. As shown in FIG. 6, a decoding apparatus of the first embodiment of the present invention comprises an integrator 120; a compare-timing generator 121; and a bit determining unit 122. The way of decoding data encoded in wobbled pattern on the disk is graphically described with reference to FIG. 7.

A wobbled wave 701 shown in FIG. 7 consists of 4-bit length (144T=4×36T) Sync body, 4-bit length (144T) Sync identification, and consecutive data bits. One bit is encoded in a wobble segment that is 36 T in length. By detecting light reflected from the wobbled pattern disposed along the tracks on the disk, the optical pickup 11 produces the wobble signal 701.

The DPLL signal 702 is a clock signal whose period is 36 T that is equal to time length of a wobble segment where 1-bit information encoded in the wobble signal. The DPLL signal 702 is a clock signal that is in phase-synchronous with a recorded signal detected from the disk 10.

The DPLL signal 702 and the wobble signal 701 is exclusive-ORed and is then integrated by the integrator 120. Or as shown in FIG. 7, the inverted signal of the exclusive-ORed signal can be integrated by the integrator 120. In this case, the integrated signal is generated by integrating ‘1’-valued signal only when the two signals have the same level values. At the rising edge of the DPLL signal 702, the compare-timing generator 121 outputs compare-timing pulses to the integrator 120 as well as the bit determining unit 122.

Upon receiving a compare-timing pulse, the integrator 120 outputs an integrated value to the bit determining unit 122 and at the same time resets the output of the integrator 120. Then, in response to the compare-timing pulse, the bit determining unit 122 receives the integrated value from the integrator 120. When the received value is approximately equal to 0% or 100% of a predetermined maximum integration value, the bit information encoded in the wobble segment is determined to ‘1’ by the bit determining unit 122. When the received value is approximately equal to 50% of the predetermined maximum integration value, the bit information encoded in the wobble segment is determined to ‘0’. The decoding operation of bit information encoded in wobbled pattern in this way has the following reason. If a wobble segment has phase transition, i.e., ‘1’ value is encoded in the wobble segment, the DPLL signal and the wobble segment have either the same waveforms or inverted waveforms, as shown in FIG. 7. Thus, the output of the integrator 120 during a period of the wobble signal 701, i.e., 36 T becomes approximately either 100% or 0% of a predetermined maximum integration value. When there is no phase transition in the wobble segment, i.e., ‘0’ value is encoded in the wobble segment, the wobble signal 701 has the same level as the DPLL signal 702 during 50% of the period of wobble signal 701 because the duty ratio of the DPLL signal 702 is 50%. Hence, in this case the output of the integrator 120 produces 50% of the predetermined maximum integration value.

Since the bit value determination described above is made after integration of wobble signal during a period of 36 T, the bit decoding output signal is delayed by the period of wobble signal, 36 T, compared to the wobble signal.

The wobble signal decoding operation enables us to accurately decode disk information encoded in wobbled pattern in the PIC area of high-density optical disks such as BD-R and BD-RE.

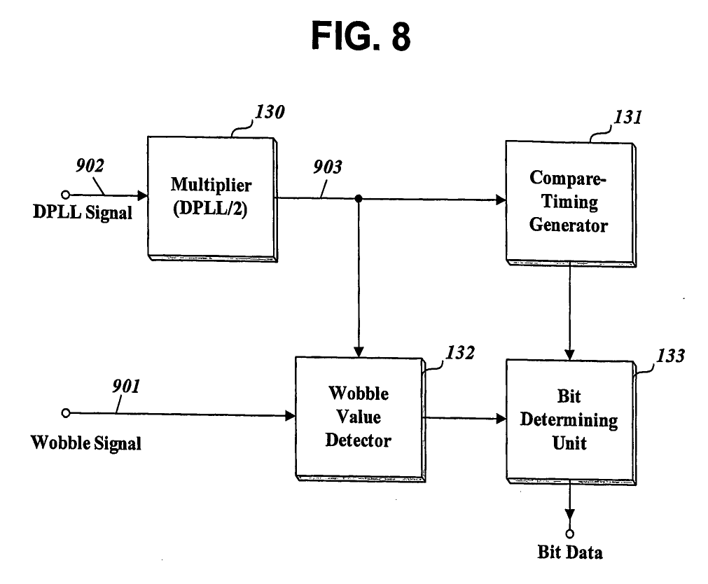

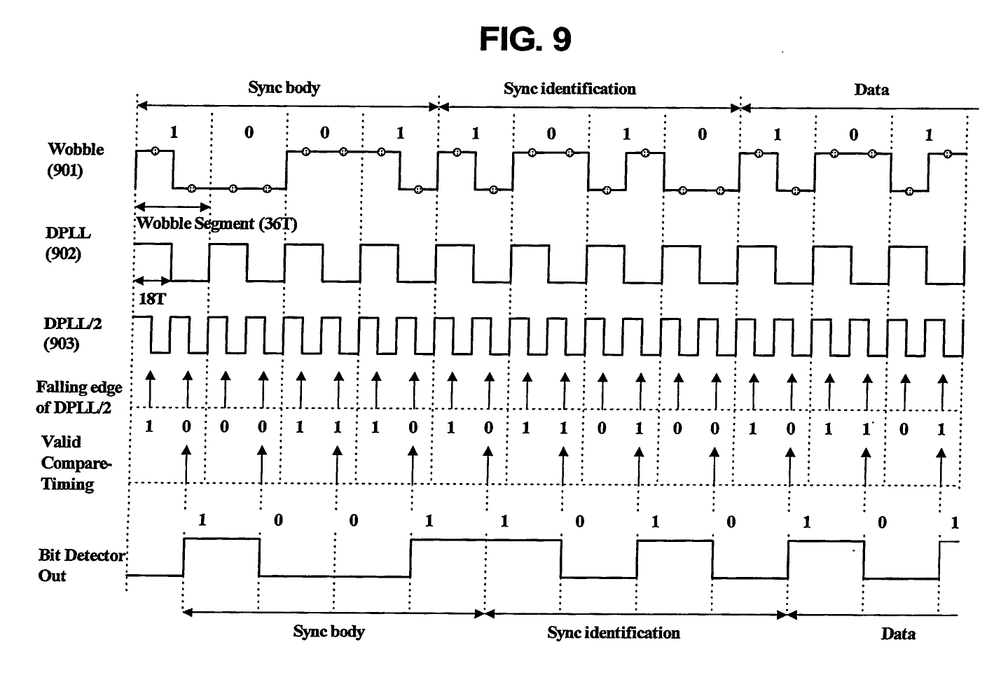

FIG. 8 illustrates a block diagram of decoding apparatus of the second embodiment of the present invention, comprising a multiplier 130; a compare-timing generator 131; a wobble value detector 132; and a bit determining unit 133. Method of decoding data encoded in wobbled pattern by the apparatus of FIG. 8 is illustrated in detail in FIG. 9.

The multiplier 130 multiplies the DPLL signal 902 by 2 to produce DPLL/2 signal 903 whose period is 18 T. The wobble value detector 132 receives the DPLL/2 signal 903 and the wobble signal 901 encoding disk information simultaneously, and detects the level value of the wobble signal 901 at the falling edge of the DPLL/2 signal 901 in order to send the detected level value to the bit determining unit 133.

On the other hand, the compare-timing generator 131 sends compare-timing pluses to the bit determining unit 133 at every even-numbered falling edge of the DPLL/2 signal 903.

The bit determining unit 133 latches two consecutive bit values that are supplied from the wobble value detector 132. In response to the compare-timing pulse, the two latched bit values are exclusive-ORed. In other words, if the two bit values are the same, i.e., (0, 0) or (1, 1), the output of the bit determining 133 becomes ‘0’, and ‘1’ otherwise.

Since the bit value determination described above is made at every 3/4 of period of the DPLL signal 902, the bit decoding output signal is delayed by 27T compared to the wobble signal 901.

The wobble signal decoding operation enables us to accurately decode disk information encoded in wobbled pattern in the PIC area of high-density optical disks such as BD-R and BD-RE.

The second embodiment of the present invention shown in FIG. 8 is more preferable in high-speed applications than the first embodiment of FIG. 6, the reason of which will be explained in detail below. At normal (1×) playback speed, the frequency of the wobble segment (the period is 36 T) is 1.83 MHz, and for instance, if sampling frequency of the integrator 120 is 50 MHz, the predetermined maximum integration value becomes to 27 (=50/1.83) approximately. However, at double (2×) playback speed, the predetermined maximum integration value becomes to 13 (=50/(2*1.83)) approximately at the same sampling frequency of 50 MHz. In this way, as the playback speed increases, the predetermined maximum integration value gets smaller, and thus the margins between 0%, 50%, 100% of the predetermined maximum integration value get smaller. As a result, low resolution of the output of the integration leads to increase of probability that bit detection error may occur. On the other hand, because bit value detection of the second embodiment of FIG. 8 is performed on the basis of level values of wobble signal without integration, the bit value can be decoded regardless of the playback speed.

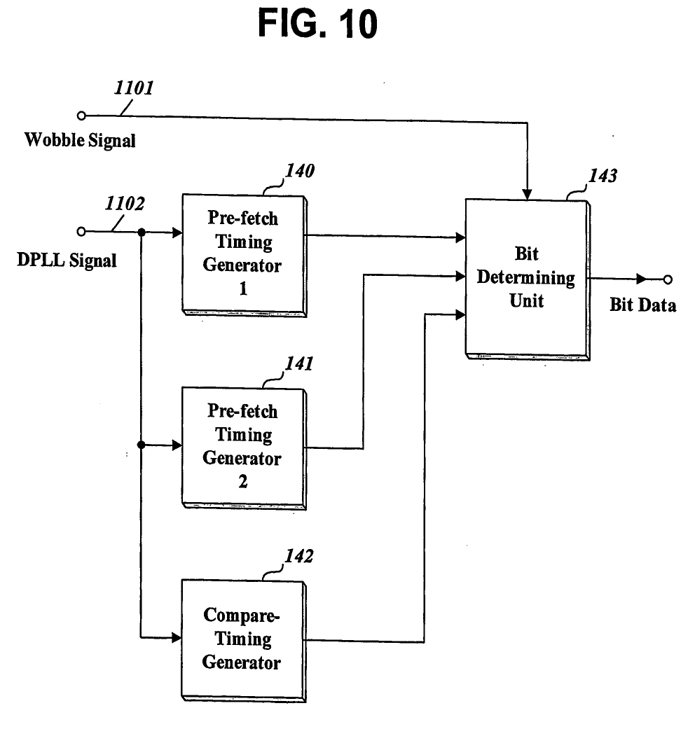

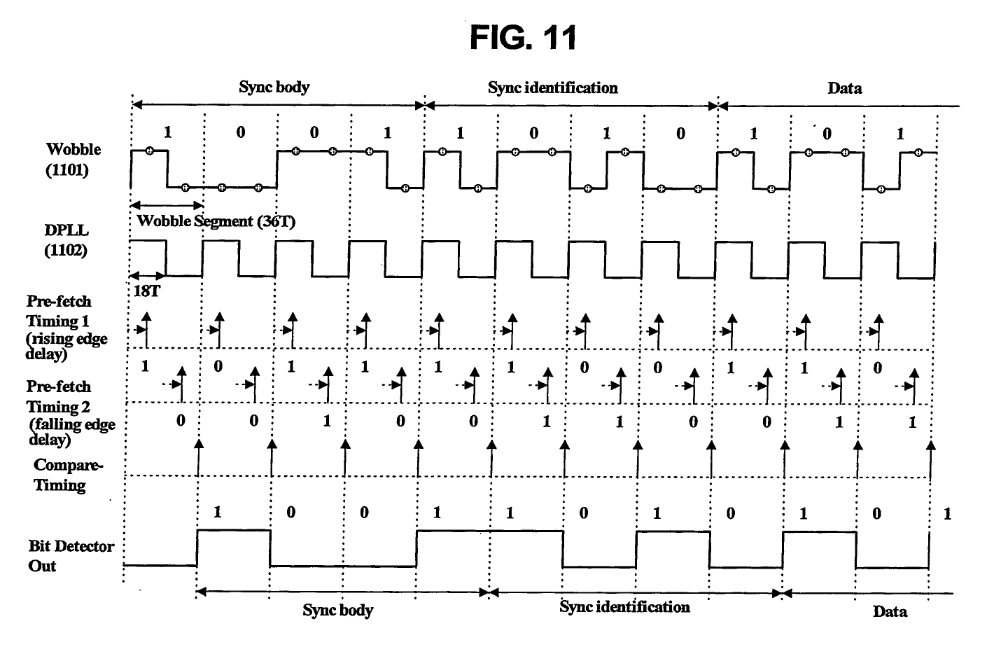

FIG. 10 illustrates a block diagram of decoding apparatus of the third embodiment of the present invention, comprising a first pre-fetch timing generator 140; a second pre-fetch timing generator 141; a compare-timing generator 142; and a bit determining unit 143. Method of decoding data encoded in wobbled pattern by the apparatus of FIG. 10 is illustrated in detail in FIG. 11.

The first pre-fetch timing generator 140 detects the rising edges of the DPLL signal 1102 of period of 36 T, and outputs a first pre-fetch timing pulse that is delayed by 9 T compared to the detected rising edge to the bit determining unit 143. The second pre-fetch timing generator 141 detects the falling edges of the DPLL signal 1102, and outputs a second pre-fetch timing pulse that is delayed by 9 T compared to the detected falling edge to the bit determining unit 143.

The compare-timing generator 142 sends compare-timing pulses to the bit determining unit 143 at every rising edge of the DPLL signal 1102.

The bit determining unit 143 latches level values of the wobble signal 1101 at the time at which either the first pre-fetch timing pulse or the second pre-fetch timing pulse is inputted. In response to the compare-timing pulse, the two latched level values are exclusive-ORed and outputted as the detected bit value. In other words, if the two bit values are the same, i.e., (0,0) or (1,1), the output of the bit determining unit 143 becomes ‘0’, and ‘1’ otherwise.

Since the bit value determination described above is made after a period of the DPLL signal 1102, 36 T, the bit decoding output signal has a delay of 36 T compared to the wobble signal.

The wobble signal decoding operation described above enables us to accurately decode disk information encoded in wobbled pattern in the PIC area of high-density optical disks such as BD-R, BD-RE, BD-ROM.

Compared to the second embodiment of FIG. 8, the third embodiment of FIG. 10 has an advantage of being easy implementable because of use of simple delay circuits, rather than multiplier 130.

Apparatus and method of decoding data encoded in wobbled pattern on a high-density optical disk described above provides a way of accurately obtaining disk information that is encoded in wobbled pattern, enabling reliable writing and/or reading data on the optical disk by using the disk information.

While the invention has been disclosed with respect to a limited number of embodiments, those skilled in the art, having the benefit of this disclosure, will appreciated numerous modifications and variations therefrom. It is intended that all such modifications and variations fall within the spirit and scope of the invention.

1. An apparatus of decoding data encoded in wobbled pattern of a recoding medium, comprising:
an optical pickup for outputting a wobble signal detected from the wobbled pattern;
a detector for detecting a property value of a wobble segment by using a clock signal whose period is equal to time length of the wobble segment, the wobble segment being a signal unit in which 1-bit information is encoded in the wobble signal; and
a determining unit for determining a bit value encoded in the wobble segment on the basis of the detected property value.

2. The apparatus as set forth in claim 1, wherein the wobbled pattern is formed in at least a PIC (permanent information and control data) zone in a lead-in area of the recording medium.

3. The apparatus as set forth in claim 1, wherein the time length of the wobble segment is 36 T.

4. The apparatus as set forth in claim 1, wherein the clock signal is generated in phase synchronous with a recorded signal detected from the recording medium.

5. The apparatus as set forth in claim 1, wherein the wobble segment and the clock signal are exclusive-ORed, integrated, and are then outputted as the property value of the wobble segment by the detector, and wherein the bit value encoded in the wobble segment is determined to a first logic value by the determining unit if the integrated value is approximately equal to 50% of a predetermined maximum integration value, and the bit value encoded in the wobble segment is determined to complement of the first logic value if the integrated value is approximately equal to either 0% or 100% of the predetermined maximum integration value.

6. The apparatus as set forth in claim 1, wherein the wobble segment and the clock signal are exclusive-ORed, inverted, integrated, and are then outputted as the property value of the wobble segment by the detector, and wherein the bit value encoded in the wobble segment is determined to a first logic value by the determining unit if the integrated value is approximately equal to 50% of a predetermined maximum integration value, and the bit value encoded in the wobble segment is determined to complement of the first logic value if the integrated value is approximately equal to either 0% or 100% of the predetermined maximum integration value.

7. The apparatus as set forth in claim 1, wherein the detector detects level values of the wobble segment at 25% and 75% points of the wobble segment, respectively, and wherein the bit value encoded in the wobble segment is determined to a first logic value by the determining unit if the two level values are equal to each other, and the bit value encoded in the wobble segment is determined to the complement of the first logic value if the two level values are not equal to each other.

8. The apparatus as set forth in claim 7, wherein a second clock signal whose period is equal to ½ of the period of the clock signal is generated by the detector, and the 25% and 75% points of the wobble segment are detected on the basis of transition points of the second clock signal.

9. The apparatus as set forth in claim 7, wherein the clock signal is delayed by ¼ of the period of the clock signal by the detector, and the 25% and 75% points of the wobble segment are detected on the basis of each transition point of the delayed clock signal.

10. A method of decoding data encoded in wobbled pattern of a recoding medium, comprising the steps of:
producing a wobble signal detected from the wobbled pattern;
detecting a property value of a wobble segment by using a clock signal whose period is equal to time length of the wobble segment, the wobble segment being a signal unit in which 1-bit information is encoded in the wobble signal; and
determining a bit value encoded in the wobble segment on the basis of the detected property value.

11. The method as set forth in claim 10, wherein the wobbled pattern is formed in at least a PIC (permanent information and control data) zone in a lead-in area of the recording medium.

12. The method as set forth in claim 10, wherein the time length of the wobble segment is 36 T.

13. The method as set forth in claim 10, wherein the clock signal is generated in phase synchronous with a recorded signal detected from the recording medium.

14. The method as set forth in claim 10, wherein in the detecting step, the wobble segment and the clock signal are exclusive-ORed, integrated, and are then outputted as the property value of the wobble segment, and wherein in the determining step, the bit value encoded in the wobble segment is determined to a first logic value if the integrated value is approximately equal to 50% of a predetermined maximum integration value, and the bit value encoded in the wobble segment is determined to complement of the first logic value if the integrated value is approximately equal to either 0% or 100% of the predetermined maximum integration value.

15. The method as set forth in claim 10, wherein in the detecting step, the wobble segment and the clock signal are exclusive-ORed, inverted, integrated, and are then outputted as the property value of the wobble segment, and wherein in the determining step, the bit value encoded in the wobble segment is determined to a first logic value if the integrated value is approximately equal to 50% of a predetermined maximum integration value, and the bit value encoded in the wobble segment is determined to complement of the first logic value if the integrated value is approximately equal to either 0% or 100% of the predetermined maximum integration value.

16. The method as set forth in claim 10, wherein in the detecting step, two level values of the wobble segment are detected at 25% and 75% points of the wobble segment, respectively, and wherein in the determining step, the bit value encoded in the wobble segment is determined to a first logic value if the two level values are equal to each other, and the bit value encoded in the wobble segment is determined to the complement of the first logic value if the two level values are not equal to each other.

17. The method as set forth in claim 16, wherein in the detecting step, a second clock signal whose period is equal to ½ of the period of the clock signal is generated, and the 25% and 75% points of the wobble segment are detected on the basis of transition points of the second clock signal.

19. The method as set forth in claim 16, wherein in the detecting step, the clock signal is delayed by ¼ of the period of the clock signal by the detector, and the 25% and 75% points of the wobble segment are detected on the basis of each transition point of the delayed clock signal.
